(19) United States
(12) Patent Application Publication
(10) Pub. No.: US 2006/0139285 A1
(43) Pub. Date: Jun. 29, 2006

(54) ELECTRONIC DEVICE CAPABLE OF DISPLAYING IMAGES

(75) Inventor: Cheng-Hong Tsai, Taipei Hsien (TW)

Correspondence Address: NORTH AMERICA INTELLECTUAL PROPERTY CORPORATION, P.O. BOX 506, MERRIFIELD, VA, 22116, US

(73) Assignee: BENQ CORPORATION, Tao-Yuan Hsien (TW)

(21) Appl. No.: 11/275,328

(22) Filed: Dec. 23, 2005

(30) Foreign Application Priority Data
Dec. 24, 2004 (TW) 093140613

(51) Int. Cl. G09G 3/36

(52) U.S. Cl. 345/98

(57) ABSTRACT

An overdrive system is disposed on a computer motherboard and generates an overdriven signal through an overdrive chip. By using a preset lookup table database in the overdrive chip, the overdrive chip optimizes image signals according to different liquid crystal display (LCD) panels to accommodate the character of each LCD panel.

### BACKGROUND OF THE INVENTION

1. Field of the Invention

The present invention relates to a computer, and more specifically, to a computer capable of lowering a gray-level response time of a liquid crystal display panel.

2. Description of the Prior Art

The liquid crystal display (LCD) panel is characterized by light weight, low power consumption, and low radiation, and is widely applied in portable electronic products such as notebook computers and personal digital assistant (PDAs). LCD monitors are so useful that cathode ray tube (CRT) monitors are being replaced.

Liquid crystal molecules have different polarization and refraction to light due to different alignment, so the amount of light transmitted can be controlled, generating light with different strength. This is how an LCD panel displays different gray-level strength of red, blue, and green light to produce rich images.

When applying an electric field to liquid crystal molecules to change their alignment, it takes some time to reach the final state due to the properties of the molecules, thus causing output delay of the screen. Therefore, overdrive technology is adopted to solve the problem of low response time of an LCD. Please refer to FIG. 1, which illustrates an overdrive chart. For instance, when employing an electric field with strength E1, E2 or E3, a liquid crystal molecule will turn to gray-level A1, A2 or A3, where E1<E2<E3 and A1<A2<A3. That is, a pixel turns from gray-level A1 to gray-level A2 when the LCD panel changes the electric field strength from E1 to E2. If the pixel is not overdriven, it takes a delay time for the pixel to change to gray-level A2 following the target gray-level curve 2. However, if we want to shorten the transformation time of the pixel from gray-level A1 to gray-level A2, the LCD panel may change an original electric field strength E1 to an electric field strength E3 greater than E2, raising the target gray-level of the pixel from A2 to A3, causing the liquid crystal molecule to change to the target gray-level A2 in a faster way following the overdrive gray-level curve 4. The overdriven transformation of the pixel is stopped once the gray-level of the pixel reaches A2. Thereby, the transformation of a pixel is sped up and the delay time of the transformation is reduced. The prior art overdrive technology uses a look up table (LUT) to store the needed target gray-level value of each gray-level transformation, where the target gray-level is used to shorten the transformation time that a pixel takes to change from a first gray-level to second gray-level on a display panel.

Please refer to FIG. 2. FIG. 2 illustrates a prior art gray level lookup table 10. The lookup table 10 comprises a first gray-level array 12, a second gray-level array 14, and a target gray-level array 16. The first gray-level array 12 comprises a plurality of first gray-level values 17, the second gray-level array 14 comprises a plurality of second gray-level values 18, and the target gray-level array 16 comprises a plurality of target gray-level values 19. Assuming the gray-level of a pixel of the display changes from gray-level 4 to gray-level 5, a target gray-level 7 will be obtained from the target gray-level array 16 of the lookup table 10. That is, as the pixel is changing from gray-level 4 to gray-level 5, the LCD display adjusts the electric field applied to the pixel from the strength corresponding to gray-level 4 to the strength corresponding to gray-level 7 instead of to the strength of gray-level 5, and stops the gray-level change of the pixel when it reaches gray-level 5. Likewise, a pixel from gray-level 6 to gray-level 3 can be adjusted according to a target gray-level 0 referencing the target gray-level array 16 of the lookup table 10 to reach gray-level 3 more quickly.

However, prior art LCD technologies all design the overdriving in the LCD panel, and due to the variety in design of different LCD manufacturers, the optimization of individual notebook systems is difficult to achieve. In addition, in prior art, notebook PCs adopt mostly lower-end LCD panels since most notebook PCs are used for non-multimedia purposes, which leads to lower gray-level response time of the LCD panel than found in generic high-end LCD displays. Thus, a significant problem in display quality still remains in multimedia applications on notebook computers. On the other hand, due to great amount of parameter transformations in overdrive technology, software or system programs implementing such will result in a serious workload to the system.

### SUMMARY OF THE INVENTION

Therefore, the primary objective of the present invention is to provide a computer having an overdrive chip installed on the motherboard to solve the above problem.

The present invention provides an electronic device comprising a first display panel comprising a plurality of display subunits, a display chip for outputting an image signal having a plurality of driving values corresponding to the plurality of display subunits, and an overdrive chip coupled with the display chip for transforming the plurality of driving values by a predetermined transformation into an overdriven display signal for driving the first display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art overdrive table.

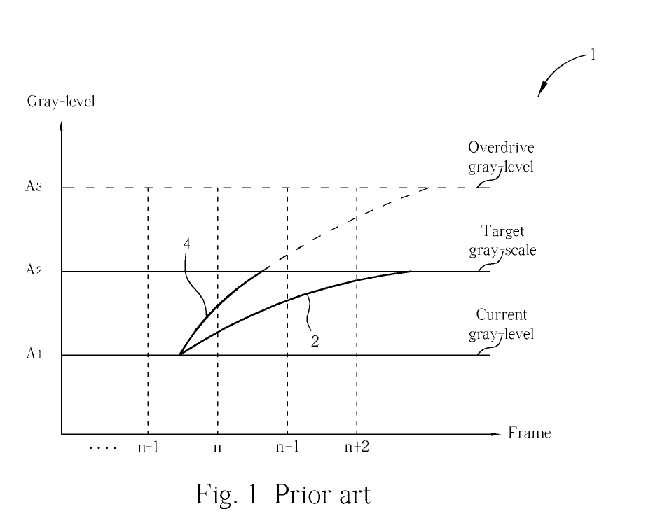

FIG. 2 illustrates a prior art gray-level lookup table.

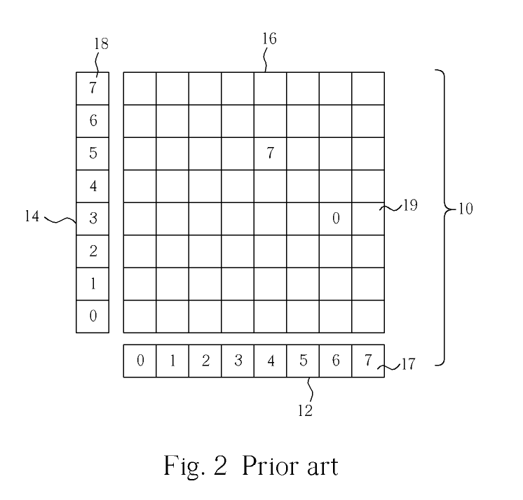

FIG. 3 illustrates a present invention notebook computer.

FIG. 4 is a functional diagram of the notebook computer in FIG. 3.

FIG. 5 is a functional diagram of the overdrive chip of the notebook computer in FIG. 3.

FIG. 6 is a functional diagram of a second present invention notebook computer.

FIG. 7 is a functional diagram of a third present invention notebook computer.

### DETAILED DESCRIPTION

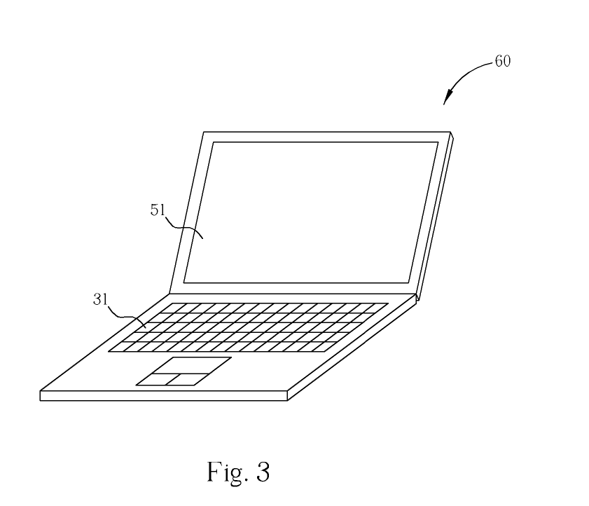

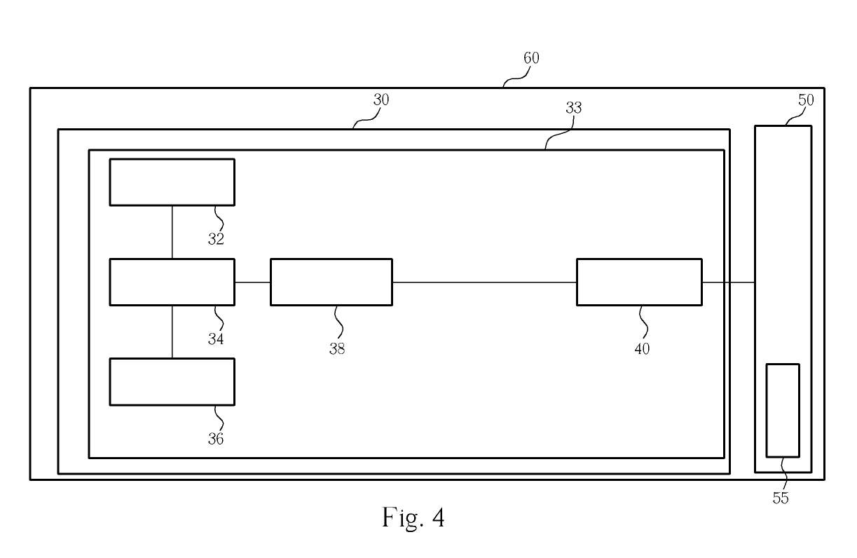

Please refer to FIG. 3 and FIG. 4. FIG. 3 illustrates a present invention notebook computer 60. FIG. 4 illustrates a functional diagram of the present invention notebook computer 60. The notebook 60 comprises a first module 30 and a second module 50. The first module 30 comprises a housing 31, a processor 32, a motherboard 33, a display chip 38 for producing image signals, and an overdrive chip 40. The second module 50 comprises a shell 51 and a display panel 55. The display panel 55 comprises a plurality of pixels. The shell 51 of the second module 50 is rotatably connected to the housing 31 of the first module 30 and receives via a bus the image signal or the overdriven signal outputted from the overdrive chip 40. The overdrive chip 40 is coupled with the display chip 38 for generating an overdriven signal according to the image signal outputted from the display chip 38.

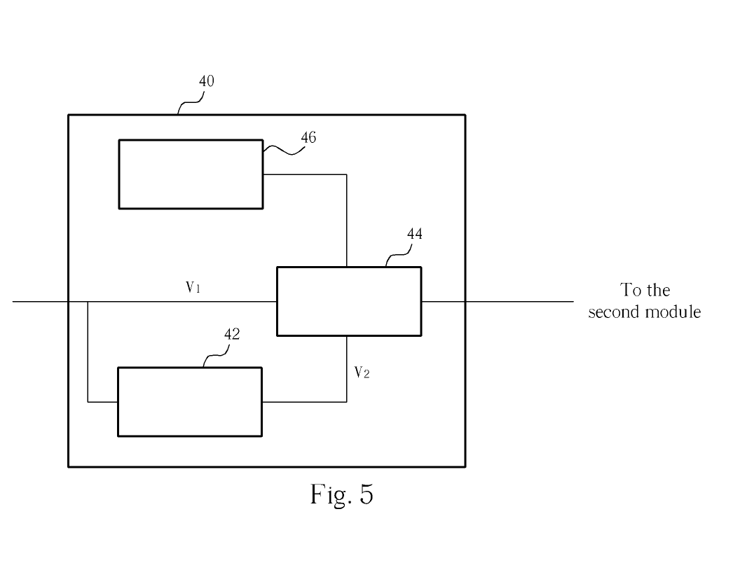

Please refer to FIG. 5, which is a functional diagram of the overdrive chip 40. The overdrive chip 40 has a buffer 42, a lookup table 44, and a lookup table database 46. When the image signal V1 generated by the display chip 38 is transmitted as a low voltage differential signal (LVDS) to the overdrive chip 40, the overdrive chip 40 reads the present frame information V2 from the buffer 42 inside, and obtains the overdriven data (overdriven signal) from the lookup table 44 according to the present frame information V2 of the buffer 42 and the image signal V1 from the display chip 38. The overdriven signal is outputted to the second module 50 for display. The overdrive chip 40 outputs the overdriven signal according to each pixel of each frame. The overdriven signal is transmitted to work on the plurality of pixels of the display panel 55, causing the plurality of pixels to reach a predetermined brightness in a second response time. Additionally, a plurality of optimized lookup tables having data for different second modules 50 are stored in the lookup table database 46. When the notebook 60 drives the second module 50, the optimized lookup table data corresponding to the second module 50 are loaded into the lookup table 44. Since the display panels 55 of different second modules 50 differ in physical properties and circuit design, the optimized overdrive information of most common display panels 55 are stored in the lookup table database 46 of the overdrive chip 40 and can be updated through a firmware upgrading process. Further, the buffer 42 can be a dynamic random access memory (DRAM) or cache, and the lookup table database 46 can be an electrically erasable programmable read-only memory (EEPROM) or another kind of storage element having similar function.

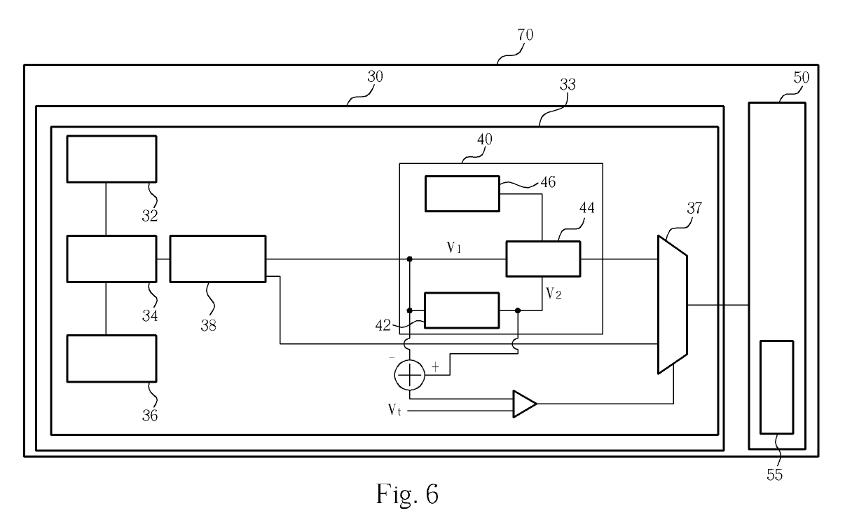

Please refer to FIG. 6, which illustrates a functional diagram of a second present invention notebook computer 70. The notebook computer 70 comprises a multiplexer 37 for deciding whether or not to activate the overdrive chip 40 to output the overdriven signal according to application configuration. When the image signal generated by the display chip 38 is transmitted directly to the plurality of pixels of the display panel 55 without going through the overdrive chip 40, the plurality of pixels get to a predetermined gray-level in a first response time. Generally, the first response time is greater than the second response time mentioned above. For applications requiring few dynamic graphics (e.g. word processors) or when the change of the image signal (V2−V1) is less than a predetermined amount Vt, the multiplexer 37 determines that the image signal generated by the display chip 38 is to be outputted directly to the second module 50 for display without first going through the overdrive chip 40. Likewise, for dynamic graphics (e.g. video or animation) or when the change of the image signal (V2−V1) is greater than the predetermined amount Vt, the image signal generated by the display chip 38 is transmitted to the overdrive chip 40 to generate the overdriven signal, and the multiplexer 37 determines to output the overdriven signal to the second module 50 for display. In addition, when the multiplexer 37 outputs the image signal directly to the second module 50, the overdrive chip 40 can be powered off at the same time to save power.

In addition, the first module 30 of the notebook 70 further comprises a north bridge chip 34 coupled with the processor 32 and the display chip 38. The north bridge communicates with the processor 32 and controls the transmission of data between the memory, the bus, and processor 32. The first module 30 of the notebook 70 further comprises a south bridge chip 36 coupled with the north bridge chip 34 for controlling the input/output bus and devices of the notebook 70.

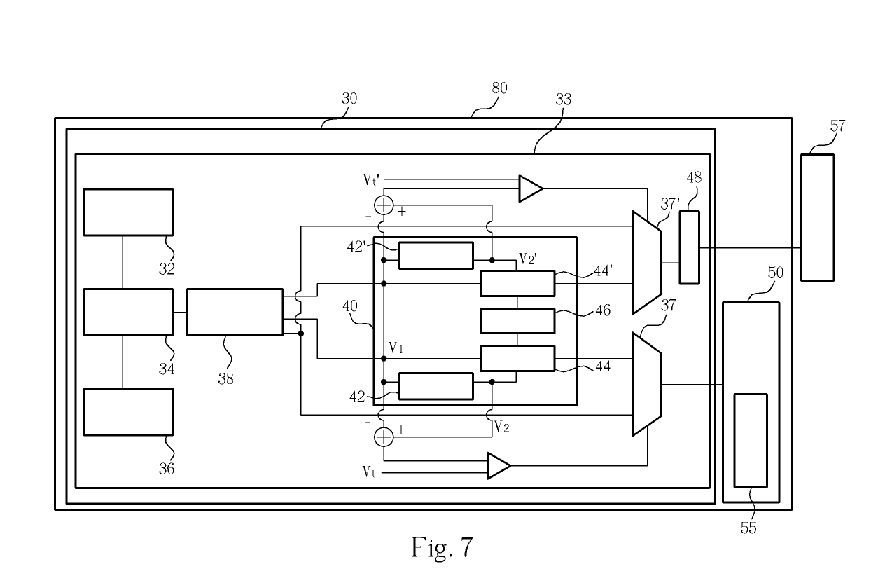

Finally please refer to FIG. 7. FIG. 7 is the functional diagram of the third kind of the present invention notebook computer 80. Different from the notebook 70, the first module 30 of the notebook 80 further comprises a first display port 48 that allows for a second display panel 57 to display the outputted image. When the notebook 80 transmits the overdriven signal to the second display panel 57 through the first display port 48, the overdrive chip 40 chooses a second lookup table corresponding to the second display panel 57 from the plurality of lookup tables of the lookup table database 46. The image signal is transformed into the overdriven signal according to the second lookup table.

LCD panels of prior art notebook computers are mostly equipped with built-in overdrive modules to reduce to response time of the liquid crystals, eliminating residual images. Unlike the prior art notebook computers, the present invention notebook computer provides a designated overdrive device on the motherboard of the notebook computer, for generating an overdriven signal for a great amount of image pixels with an independent overdrive chip. This largely reduces the loading of the CPU and optimizes the overdriven signal from the outputted image signal. The present invention eliminates the need of the LCD panel to perform overdriving and further tunes the overdrive chip for optimization of different LCD panels to generate the best output signal. Before outputting the image signal to the LCD panel, the image signal has been overdriven in advance, therefore, the present invention largely reduces the gray-level response time of an LCD panel, which solves the problem of residual images in the prior art.

Finally, the present invention is not limited to application in a notebook computer. Any electronic device having a display panel can use the present invention, too.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a first display panel comprising a plurality of display subunits;
a display chip for outputting an image signal having a plurality of driving values corresponding to the plurality of display subunits; and
an overdrive chip coupled with the display chip for transforming the plurality of driving values by a predetermined transformation into an overdriven display signal for driving the first display panel.

2. The electronic device of claim 1, wherein a first lookup table is stored in the overdrive chip, and the plurality of driving values are transformed into the overdriven display signal corresponding to the first lookup table.

3. The electronic device of claim 1, wherein the overdrive chip comprises a plurality of lookup tables corresponding to a plurality of different display panels, and as the electronic device selects a second display panel as an output display panel instead of the first display panel, the overdrive chip selects a second lookup table from the plurality of lookup tables, and the plurality of driving values are transformed into the overdriven display signal corresponding to the second lookup table.

4. The electronic device of claim 1 further comprising:
a multiplexer connected to the display chip and an output of the overdrive chip, the multiplexer for outputting the image signal to the first display panel when the variation of the image signal is less than a predetermined amount and outputting the overdriven display signal to the first display panel when the variation of the image signal is greater than the predetermined amount.

5. The electronic device of claim 4, wherein when the multiplexer outputs the image signal to the first display panel, the overdrive chip is powered off.

6. The electronic device of claim 1, wherein a first response time of the plurality of display subunits applied with the image signal is longer than a second response time of the plurality of display subunits applied with the overdriven display signal.

7. The electronic device of claim 6, wherein the first response time and the second response time are times for the plurality of display subunits to reach a target gray level.

8. The electronic device of claim 1 wherein the electronic device is a folding electronic device comprising:
a first module comprising:
a motherboard having the display chip and the overdrive chip installed thereon; and
a second module connected rotatably to the first module, the second module having the display panel installed therein for receiving the overdriven display signal via a bus.

9. The electronic device of claim 8, wherein the first module further comprises a north bridge chip coupled with the display chip.

10. The electronic device of claim 9, wherein the first module further comprises a south bridge chip coupled with the north bridge chip.

11. The electronic device of claim 1 further comprising:
a plurality of lookup tables corresponding to a plurality of different display panels; and
a first display port for connecting a second display panel;
wherein as the electronic device transmits the overdriven display signal through the first display port to the second display panel, the overdrive chip selects a second lookup table from the plurality of lookup tables corresponding to the second display panel, and the plurality of driving values are transformed into the overdriven display signal corresponding to the second lookup table.
